(19) United States
(12) Patent Application Publication
(10) Pub. No.: US 2008/0084394 A1
(43) Pub. Date: Apr. 10, 2008

(54) Device for inputting information

(75) Inventor: Eung-Cheon Kang, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/905,966

(22) Filed: Oct. 5, 2007

(30) Foreign Application Priority Data
Oct. 10, 2006 (KR) 10-2006-0098517

(51) Int. Cl. G06F 3/033

(52) U.S. Cl. 345/166

(57) ABSTRACT

An information input device is disclosed. A device for inputting information, which includes: an integrated board coupled inside a flat main body; a rotary input module that includes a maneuver part, which is rotatably supported by a support part secured to the board, and a detector part, which generates signals in correspondence to the rotation of the maneuver part, where the maneuver part is exposed at one side of the main body; and an optical module secured to the board such that the optical module is adjacent to the rotary input module and exposed at the other side of the main body, where the optical module generates signals in correspondence with the movement of the main body, allows a small volume for convenient use and portability, and does not require FPCB's, so that costs may be reduced and assembly may be facilitated.

### CROSS-REFERENCE TO RELATED APPLICATIONS

This application claims the benefit of Korean Patent Application No. 10-2006-0098517 filed with the Korean Intellectual Property Office on Oct. 10, 2006, the disclosure of which is incorporated herein by reference in its entirety.

### BACKGROUND

1. Technical Field

The present invention relates to a device for inputting information.

2. Description of the Related Art

An information input device, such as a mouse, is widely being used as hardware for inputting information in electronic apparatus such as personal computers and laptops, etc. In particular, with the use of Windows from Microsoft Corporation as the OS (operating system) in computers, the mouse has rapidly been popularized as an inputting means besides the keyboard.

FIG. 1 is a perspective view of a mouse, an example of a conventional information input device. Referring to FIG. 1, a conventional mouse includes a main frame 110 that has a flat bottom surface, a grip part 120 formed at the upper side of the main frame 110 that allows gripping for a hand, buttons 130 formed at the front of the grip part 120 that can be pressed by a finger, etc., a sensor part formed at the lower side of the main frame 110 that recognizes position changes of the mouse 100, and a cable 150 for connecting the mouse 100 to an electronic apparatus such as a personal computer. A wheel 160 is formed between the buttons 130.

The user moves the mouse 100 two-dimensionally over a mouse pad, to move a cursor, etc., to a desired position, and then clicks a button 130 to run a corresponding icon, etc. Also, to move the screen on the display of the computer up or down, the wheel 160 is rotated forward or backward with respect to the user.

However, as the conventional information input device has a convex shape for easy holding by the user, it is inevitably given a large volume. Also, since the wheel 160, one of the inputting means, is positioned perpendicularly to the work surface, such as the pad, there is a limit to how much the volume of the information input device can be reduced.

Furthermore, the conventional mouse is structured to have modularized input devices of the buttons or wheel, which are connected to the main board using an FPCB (flexible printed circuit board) as the terminal, with a connector formed on the main board for connecting the input device. Thus, high costs are involved in manufacturing the FPCB, and because the input device modules have to be connected to the main board, there is difficulty in assembly.

### SUMMARY

An aspect of the invention is to provide a device for inputting information, which has a small volume for convenient use and portability, and in which input modules are mounted directly on the board without using separate connection terminals, such as FPCB's, etc., for reduced costs and facilitated assembly.

One aspect of the invention provides a device for inputting information, which includes: an integrated board coupled inside a flat main body; a rotary input module that includes a maneuver part, which is rotatably supported by a support part secured to the board, and a detector part, which generates signals in correspondence to the rotation of the maneuver part, where the maneuver part is exposed at one side of the main body; and an optical module secured to the board such that the optical module is adjacent to the rotary input module and exposed at the other side of the main body, where the optical module generates signals in correspondence with the movement of the main body.

A winding device may further be included which is secured to the board such that the winding device is adjacent to the optical module, and which by elastic force automatically winds a wire that is connected to an external device and configured to transmit signals generated by the rotary input module and the optical module to the external device. A circuit pattern may be formed on the board that electrically connects the rotary input module and the optical module and the wire. A thickness of the main body may correspond to the maximum value among the thicknesses of the rotary input module, the optical module, or the winding device. One end portion of the wire may be connected with a USB connector, which is connected to the external device.

The board may be formed to have a shape corresponding to an appearance of the rotary input module and the optical module, while a portion of the board facing the optical module may be removed such that a portion of the optical module is exposed at the other side of the main body.

The maneuver part may include a wheel, and a multi-pole ring-shaped magnet coupled to the wheel that faces the detector part, while the detector part may include a Hall sensor which detects changes in polarity of the magnet and generates a signal accordingly.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a mouse, an example of a conventional information input device.

FIG. 2 is a perspective view of an information input device according to an embodiment of the present invention.

FIG. 3 is a perspective view of an information input device, with the upper case removed, according to an embodiment of the present invention.

FIG. 4 is a perspective view of the reverse side of an information input device according to an embodiment of the present invention.

FIG. 5 is an exploded perspective view of a rotary input module of an information input device according to an embodiment of the present invention.

FIG. 6 is a cross-sectional view of a rotary input module of an information input device according to an embodiment of the present invention.

FIG. 7A, FIG. 7B, FIG. 7C, and FIG. 7D are plan views representing a flow diagram for a process of assembling an information input device according to an embodiment of the present invention.

FIG. 7E, FIG. 7F, FIG. 7G, and FIG. 7H are cross-sectional views representing a flow diagram for a process of assembling an information input device according to an embodiment of the present invention.

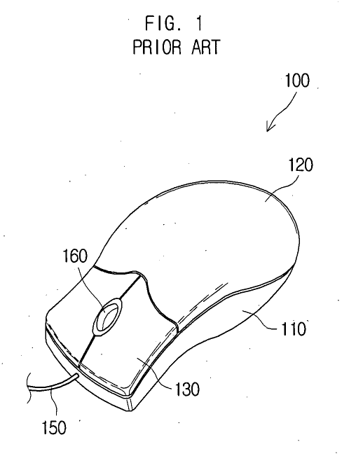

### DETAILED DESCRIPTION

The device for inputting information according to certain embodiments of the invention will be described below in more detail with reference to the accompanying drawings, in which those components are rendered the same reference numeral that are the same or are in correspondence, regardless of the figure number, and redundant explanations are omitted.

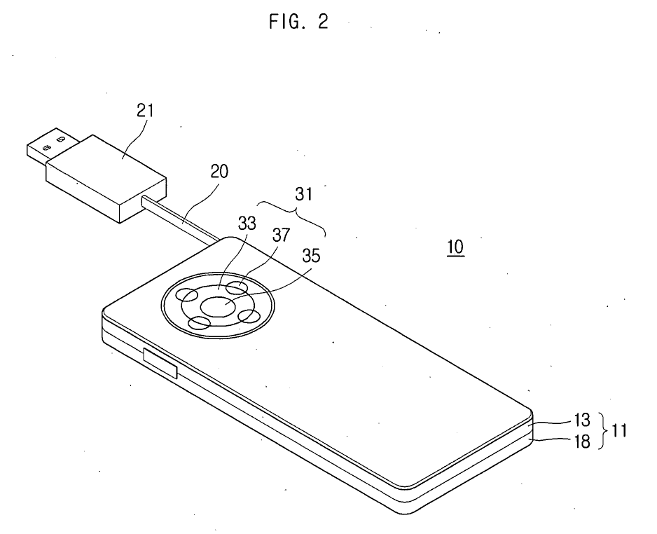

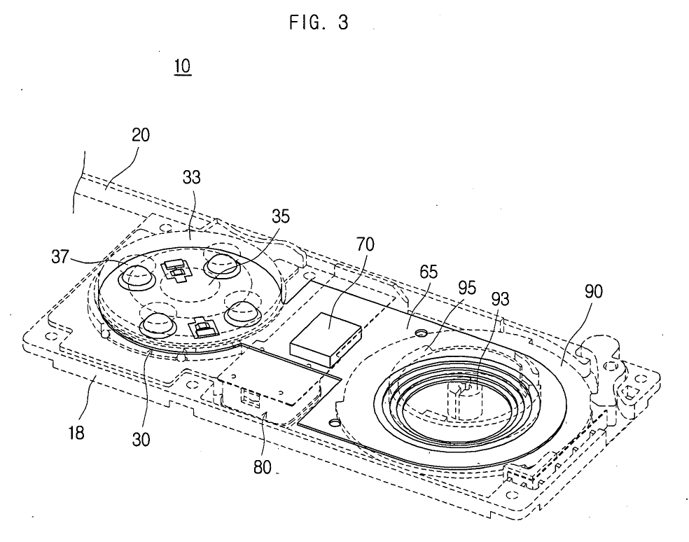

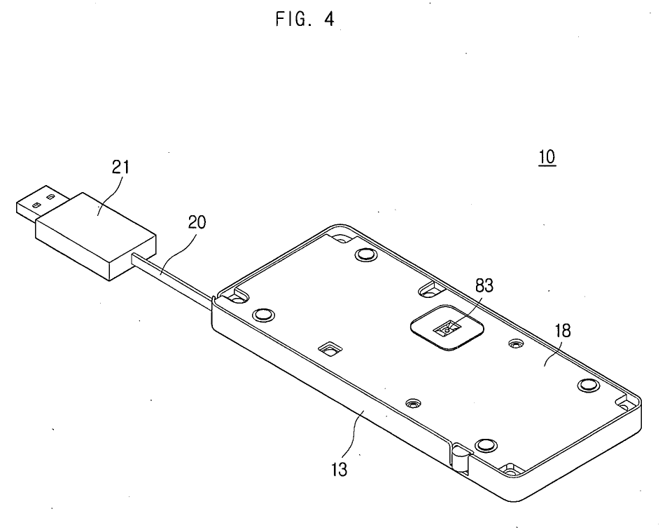

FIG. 2 is a perspective view of an information input device according to an embodiment of the present invention, FIG. 3 is a perspective view of an information input device with the upper case removed, according to an embodiment of the present invention, and FIG. 4 is a perspective view of the reverse side of an information input device according to an embodiment of the present invention. In FIGS. 2 to 4 are illustrated a mouse 10, a main body 11, an upper case 13, a lower case 18, a wire 20, a USB connector 21, a rotary input module 30, a wheel 33, a center key 35, side keys 37, a board 65, an optical module 80, a lens 83, a winding device 90, a securing protrusion 93, and a rotary bobbin 95.

This embodiment illustrates a slim-type mouse 10, to which an infinitely rotatable rotary input module 30 is applied, in which the board 65 on which to mount the rotary input module 30, optical module 80, and winding device 90, etc., is formed as an integrated body, so that the slim mouse 10 may be manufactured easily and inexpensively, without a separate connection structure such as an FPCB, etc. The present embodiment will be described below with regards a mouse 10, as an example of a device for inputting information.

As illustrated in FIG. 2, the mouse 10 according to this embodiment may be shaped substantially as a flat cuboid, with the main body 11 composed basically of an upper case 13 and a lower case 18. Forming the main body 11 to have this flat shape may allow convenient portability, because when carrying the mouse 10, it may readily be inserted into the main body of a laptop computer, etc. The main body 11 may be formed to have a small thickness for even more convenient portability, and for a more desirable appearance, deco spin processing, etc., may be applied to the upper surface of the upper case 13, etc. The length and width of the main body 11 may be formed to allow convenient gripping and easy carrying by the user, and it is to be appreciated that the shape of the main body 11 is obviously not limited to a cuboidal shape, and that any shape may just as well be used that allows easy carrying and convenient use.

An integrated-type board 65 may be coupled inside this flat shaped main body 11, where a rotary input module 30 and an optical module 80 may-be mounted adjacent to each other on the board 65.

The rotary input module 30 is a component which may serve to generate signals corresponding to a clicking, dragging, or scrolling action, etc., taken by the mouse 10, and may be composed of a maneuver part, which is rotatably supported by a support part, and a detector part, which generates signals in correspondence to the rotation of the maneuver part. In this embodiment, the rotary input module 30 is applied, which is rotatable in a horizontal direction, instead of the conventional wheel, which is coupled in a vertical direction with respect to the work plane. This may be seen as the “horizontal rotation wheel key”, used in mobile phones, etc., applied to a mouse 10. The structures and operations of the maneuver part and the detector part will be described later.

In a portion of the upper case 13, the maneuver part 31 of the rotary input module 30 may be exposed to the exterior, where a user may turn the wheel 33 or press the center key 35 formed in the center of the wheel 33, while holding the main body 11, using an index finger, etc., to input information. As illustrated in FIG. 3, the rotary input module 30, the optical module 80, and the winding device 90 may be sequentially coupled to the lower case 18, which couples with the upper case 13 to form an internal space.

The optical module 80, which may be connected by an optical module connector 70 and secured to the board 65, to generate signals in correspondence to the movement of the main body 11, may be exposed towards the bottom surface of the main body 11. That is, as the main body 11 of the mouse 10 is moved by the user's maneuvering, the optical module 80 may generate corresponding signals and transfer the signals through the wire 20 to an external device. The optical module 80, as illustrated in FIG. 4, may have a light source, such as an LED, that emits light through a lens 83, and a sensor that recognizes the light reflected from the bottom surface to sense the movement distance and direction of the main body 11, and may transmit corresponding signals to the external device, whereby a pointer may be moved to a desired position on a display installed on the external device. The specific composition and operation method of the optical module 80 are of common knowledge in the relevant field of art, and thus will not be provided in further detail. In the mouse 10 according to the present embodiment, an optical module 80 having a small thickness may be used to implement a “slim mouse”.

Adjacent to such rotary input module 30 and optical module 80, a winding device 90 may additionally be mounted on the board 65.

That is, a wire 20 may be equipped at the front of the main body 11 that connects the mouse 10 according to an embodiment of the invention with an external device (not shown). The wire 20, as illustrated in FIG. 3, may be automatically wound by the winding device 90. The wire 20 may be unwound by the user to be extended to the exterior, and when being carried, may be wound automatically with a slight pull by the hand, by means of the elastic force of a spiral spring equipped inside the winding device 90. Signals generated by the rotary input module 30 and optical module 80 formed inside the information input device 10 may be transmitted through the wire 20 to the external device (not shown). At one end portion of the wire 20, there may be a terminal, such as a USB connector 21, that connects to the external device.

The winding device 90 may be secured to the inside of the main body 11 and may wind the wire 20. In the winding device 90, a spiral spring (not shown) may be secured to a support protrusion 93, as described above, to provide a rotational force to a rotary bobbin 95. The wire 20 may be wound automatically around the rotary bobbin 95. That is, while the wire 20 may be pulled out by hand by the user when it is extracted from the inside of the case 11, the wire 20 may be pulled slightly, when the wire 20 is to be wound up, at which the rotary bobbin 95 may be made to rotate by the elastic force of the spiral spring such that the wire 20 may be wound automatically. The specific composition of the winding device 90 is of common knowledge in the relevant field of art, and thus will not be provided in further detail.

According to this embodiment, as the rotary input module 30, optical module 80, and winding device 90 may be mounted on one integrated-type board 65, a circuit pattern may advantageously be formed beforehand on the board 65 such that signals generated from the rotary input module 30 and optical module 80 may be transmitted through the wire 20. In other words, the positions where the rotary input module 30 and optical module 80 are to be coupled on the integrated board 65 may be decided beforehand, and then the Hall sensor 69, dome buttons 67, 68, optical module connector 70, and circuit pattern, etc., may be formed, after which the rotary input module 30, optical module 80, and wire 20 may each be coupled to the respective position, so that electrical connections may immediately be implemented between each module and the wire 20.

The mouse 10 according to the present embodiment has the rotary input module 30, optical module 80, and winding device 90 mounted on the board coupled inside, and in order to implement a “slim mouse”, each module may be arranged on the lower case 18 without overlapping. Therefore, the thickness of the main body 11 may be determined by whichever has the greatest, thickness from among the rotary input module 30, optical module 80, and winding device 90. Thus, as described above, it may be desirable that the optical module 80 mounted be of a thickness no greater than those of the other modules.

As illustrated in FIG. 2 and FIG. 4, at one end of the wire 20 of the mouse 10 according to this embodiment, there may be a USB connector 21 that can be coupled to a USB terminal of an external device. Thus, if the mouse 10 is connected to the USB terminal of a PC, etc., the mouse 10 may be automatically recognized by the PNP (plug and play) function. However, it is to be appreciated that the mouse 10 according to this embodiment does not necessarily have to be connected to a USB terminal, and may just as well be connected to any other type of terminal that can recognize the mouse 10.

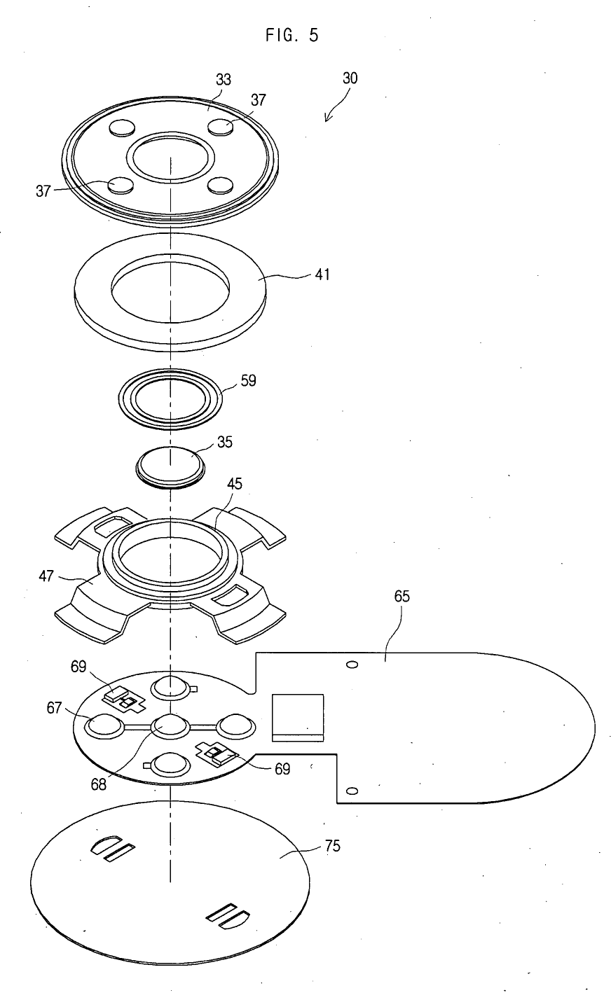

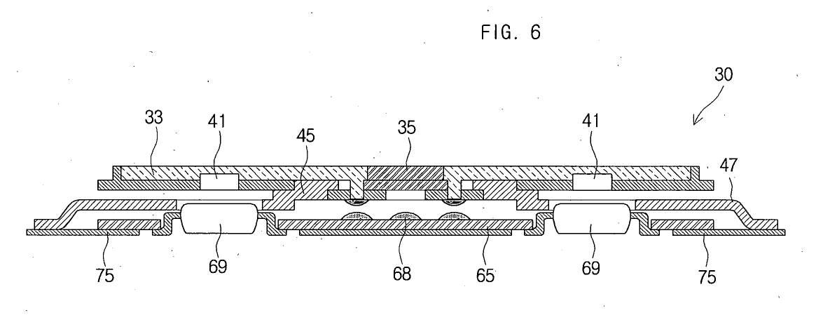

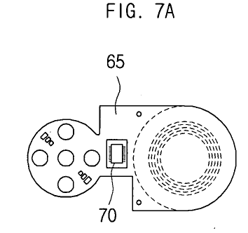

FIG. 5 is an exploded perspective view of a rotary input module of an information input device according to an embodiment of the present invention, and FIG. 6 is a cross-sectional view of a rotary input module of an information input device according to an embodiment of the present invention. In FIGS. 5 and 6 are illustrated a rotary input module 30, a wheel 33, a center key 35, side keys 37, a magnet 41, a holder 45, supporting legs 47, a washer 59, a board 65, side dome buttons 67, a center dome button 68, Hall sensors 69, and a base 75.

In a mouse 10 according to this embodiment, a rotary input module 30 may be equipped, which is infinitely rotatable in a horizontal direction, where the rotary input module 30 may be constructed with a multi-pole ring type magnet 41 attached to a wheel 33 rotatably supported on a support part, such that the magnet 41 is rotated in accordance with the rotation of the wheel 33. Hall sensors 69 may be fitted in positions facing the magnet 41, so that the Hall sensors 69 may detect the degree of change in polarity caused by the rotation of the magnet 41 and generate signals correspondingly.

In FIGS. 5 and 6 are illustrated a rotary input module 30, in which the wheel 33, center key 35, side keys 37, and magnet 41 correspond to a maneuver part, which generates signals according to the maneuvering of the user, the holder 45, supporting legs 47, and base 75 correspond to a support part, which structurally supports the maneuver part to allow rotational movement, and the side dome buttons 67, center dome button 68, and Hall sensors 69 correspond to the detector part, which generates and processes signals in correspondence to the rotational movement of the maneuver part.

A board 65 manufactured as an integrated type may serve as a support part, to structurally support the rotary input module, while at the same time serving as a detector part, having dome buttons 67, 68, and Hall sensors 69 mounted and a circuit pattern formed thereon to generate and transmit signals. The rotary input module 30 will be described below in more detail.

The rotary input module 30 may be secured horizontally to the lower case 18 of the main body 11, with the wheel 33 exposed through the upper case 13 to the exterior. As the user rotates the wheel 33 of the rotary input module 30, a function may be activated similar to the function of the wheel mounted vertically in a conventional mouse, etc. Whereas the conventional mouse wheel is mounted vertically with respect to the bottom surface, the rotary input module 30 based on the present embodiment is mounted horizontally with respect to the bottom surface, so that it is possible to reduce the volume. By rotating the wheel 33 clockwise or counterclockwise, a “scroll” function may be performed, such as moving the screen up or down in the display of an external device.

The wheel 33 may generally be shaped as a circular plate, with an insertion hole formed in the center through which the center key 35 may be inserted. The wheel 33 may have a plurality of securing protrusions that protrude downwards adjacent to the insertion hole. The securing protrusions may be inserted into the circular guide rail formed in the washer 59, such that the wheel 33 may be secured to the holder 45 in a way that allows 360 degree rotation. On the lower surface of the wheel 33 may be secured the magnet 41, which is magnetized to have multiple poles. The wheel 33 may be rotated together with the magnet 41 by user operation, whereby a variety of inputs may be made as the Hall sensors 69 sense the rotation angle, direction, and speed, etc., of the magnet 41. Also, a portion may be pressed by the user, so that a securing protrusion formed on the reverse side of the holder 45 may press a side dome button 67 or a center dome button 68 to input information.

The magnet 41 may be attached to the lower surface of the wheel 33 to be rotated together with the wheel 33, where such rotation of the magnet 41 may be sensed by the Hall sensors 69 for an input based on the rotation angle. The magnet 41 may have the shape of a ring magnetized to have alternating N- and S-poles, where the Hall sensors 69 may detect the rotation angle, direction, and speed of the wheel 33 according to the changes in N- and S-poles above the Hall sensors 69.

The holder 45 may be secured to one side of the base 75 and may rotatably support the wheel 33. The holder 45 may be made of metal, such as stainless steel, etc., so that when the particular force applied on the wheel 33 is removed, the wheel 33 may return to its original position due to the elasticity of the holder 45 itself. The holder 45 may be formed by press processing, etc. Of course, the holder 45 may also be formed by plastics, etc., that are high in elasticity.

The holder 45 may include a ring-shaped body portion, and supporting legs 47 protruding from the perimeter of the body portion that are secured to one side of the base 75. The body portion may have a hole in the middle, and the supporting legs 47 may be formed protruding out around the hole in four directions. The ends of the supporting legs 47 may be secured to the upper portion of the base 75, so as to secure the holder 45.

Since the holder 45 maybe secured directly to one side of the base 75 by means of adhesive, etc., the rotary input module 30 according to this embodiment may show superb endurance to external impact. Also, the elasticity of the holder 45, which is formed of metal, allows not only the holder 45 itself but also the wheel 33 to be restored to their original positions, to provide a better tactile feel.

In the board 65 based on the present embodiment, the portion of the board 65 to which the rotary input module 30 is coupled may have the shape of a circular plate in correspondence with the base 75, with a center dome button 68 and a plurality of side dome buttons 67 formed on one side in correspondence with the pressing of the securing protrusions protruding from the wheel 33.

The center dome button 68 may be pressed by the center key 35, and the side dome buttons 67 may be pressed by the securing protrusions 39, to input information. Pressing a side dome button 67 may perform a click function, such as in a conventional mouse, while pressing the center dome button 68 may perform a wheel click function. While this embodiment illustrates dome buttons as being pressed by the wheel 33, the invention is not thus limited. It is to be appreciated that instead of the dome buttons, pressure sensors or contact sensors, for example, may just as well be used.

In a rotary input module 30 according to this embodiment, the element for detecting changes in polarity of the magnet 41 rotating together with the wheel 33 may be a Hall sensor (Hall effect sensor), which is a silicon semiconductor using the effect of electromotive forces generated when electrons experience the Lorentz force in a magnetic field and their direction is curved. The Hall sensors 69 may generate electromotive forces that are proportional to the rotation of the magnet 41 attached to the wheel 33, which may be transferred via the board 65 to an external control device (not shown).

Of course, the detection element is not necessarily limited to a Hall sensor, and any element may be used which is able to detect the rotation of the magnet 41. For example, an MR (magneto-resistive) sensor or a GMR (giant magneto-resistive) sensor may be used for the detection element. An MR sensor or a GMR sensor is an element of which the resistance value is changed according to changes in the magnetic field, and utilizes the property that electromagnetic forces curve and elongate the carrier path in a solid to change the resistance. Not only are MR sensors or GMR sensors small in size with high signal levels, but also they have excellent sensitivity to allow operation in low-level magnetic fields, and they are also superb in terms of temperature stability.

The base 75, as illustrated in FIG. 5, may have the shape of a circular plate, and may support the holder 45 and the wheel 33.

A description will be provided below on the operation of the rotary input module 30 according to this embodiment.

When a rotational force is applied by a user on the wheel 33, the wheel 33 may be rotated while coupled to the holder 45, which causes the magnet 41 to also rotate together with the wheel 33. As the magnet 41 may have a multiple number of alternately magnetized N- and S-poles, the Hall sensors 69 may sense the changes in poles due to the rotation of the magnet 41, to identify the rotation direction, speed, and angle of the wheel 33. The Hall sensors 69 may generate output signals corresponding to the rotation direction, rotation angle, and rotation speed of the wheel 33, which are transmitted via the board 65 to an external control device, and the control device may recognize the output signals to perform an input corresponding to the rotation of the wheel 33.

Also, when a portion of the wheel 33 is pressed by a user, it may be tilted in one direction while elastically supported by the holder 45, which may cause a securing protrusion formed on the lower side to press a side dome button 67. Accordingly, the side dome buttons 67 positioned on the board 65 may perform particular preconfigured functions. When the user presses the center key 35, the center dome button 68 may be pressed, which may also perform a particular preconfigured function, just as the side dome buttons 67.

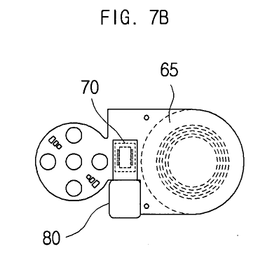

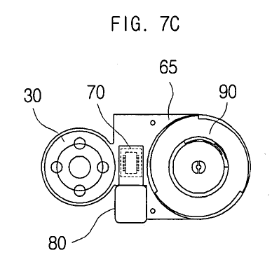

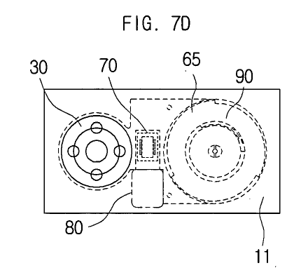

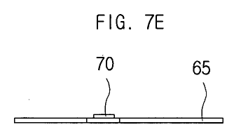

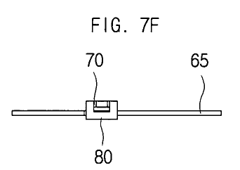

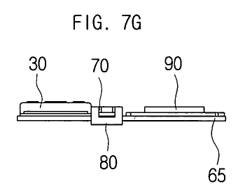

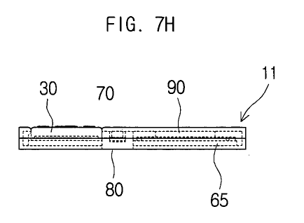

FIG. 7A, FIG. 7B, FIG. 7C, and FIG. 7D are plan views representing a flow diagram for a process of assembling an information input device according to an embodiment of the present invention, and FIG. 7E, FIG. 7F, FIG. 7G, and FIG. 7H are cross-sectional views representing a flow diagram for a process of assembling an information input device according to an embodiment of the present invention. In FIGS. 7A to 7H are illustrated a main body 11, a rotary input module 30, a board 65, an optical module connector 70, an optical module 80, and a winding device 90.

FIGS. 7A to 7D are plan views, while FIGS. 7E to 7H are side views. As illustrated in FIG. 7A, the board 65 according to this embodiment may be designed considering beforehand the positions where the rotary input module 30, optical module 80, and winding device 90 are to be secured and connected, and thus may be formed with a shape similar to its appearance after each module is secured at the corresponding position.

The portion where the rotary input module 30 is to be secured may have a circular shape, as described with reference to FIGS. 5 and 6, and the positions where the dome buttons 67, 68 and Hall sensors 69, etc., are to be mounted may be designed thereon. Thus, the board 65 according to this embodiment may have the shape of an optical module connector 70 coupled to a flat plate, as shown in FIG. 7E.

The optical module connector 70 may be formed where the optical module 80 is to be connected, and as shown in FIG. 7F, a mouse according to the present embodiment may be conveniently assembled simply by connecting the optical module 80 to the optical module connector 70.

In the optical module 80, as a portion may have to be exposed to the bottom surface of the main body 11 to emit light and receive reflected light, it may be desirable that the corresponding portion of the board 65 be removed, as in FIGS. 7A and 7B, such that the portion of the optical module 80 is not obstructed by the board 65. For this, an indentation or a hole may be formed in the corresponding portion when designing the shape of the board 65.

Similar to the rotary input module 30, the portion where the winding device 90 is to be secured may have a circular shape in accordance with the appearance of the winding device 90. By perforating beforehand a detent hole, etc., for coupling at the corresponding portion of the board 65 in correspondence with the appearance of the winding device 90, the assembly may be completed conveniently, simply by fitting the winding device 90 in the detent hole.

In order to electrically connect the rotary input module 30 and the optical module 80 to the wire wound on the winding device 90 as described above, a circuit pattern may be formed on the board 65 according to the present embodiment. Thus, the assembly of the mouse can be completed in a simple manner by coupling each module and the winding device 90 to the board as in FIGS. 7C and 7G, and fitting in the case, i.e. the main body 11, as in FIGS. 7D and 7H.

According to certain embodiments of the invention as set forth above, the rotary input module, optical module, and winding device are mounted on an integrated board inside a slim type mouse, which has a small volume for convenient use and portability, so that FPCB's are not required, and thus costs may be reduced and assembly may be facilitated.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An information input device comprising:
an integrated-type board coupled inside a flat main body;
a rotary input module comprising a maneuver part rotatably supported by a support part secured to the board, and a detector part configured to generate a signal in correspondence to a rotation of the maneuver part, the maneuver part being exposed at one side of the main body; and
an optical module secured to the board such that the optical module is adjacent to the rotary input module and exposed at the other side of the main body, the optical module configured to generate a signal in correspondence with a movement of the main body.

2. The information input device of claim 1, further comprising a winding device secured to the board such that the winding device is adjacent to the optical module, the winding device configured to automatically wind by elastic force a wire, the wire connected to an external device and configured to transmit a signal generated by the rotary input module and the optical module to the external device.

3. The information input device of claim 2, wherein a circuit pattern is formed on the board, the circuit pattern electrically connecting the rotary input module and the optical module and the wire.

4. The information input device of claim 2, wherein a thickness of the main body is in correspondence with a maximum value among thicknesses of the rotary input module or the optical module or the winding device.

5. The information input device of claim 2, wherein one end portion of the wire is connected with a USB connector, the USB configured to enable connection to the external device.

6. The information input device of claim 1, wherein the board is formed to have a shape corresponding to an appearance of the rotary input module and the optical module.

7. The information input device of claim 6, wherein a portion of the board facing the optical module is removed such that a portion of the optical module is exposed at the other side of the main body.

8. The information input device of claim 1, wherein the maneuver part comprises a wheel, and a multi-pole ring-shaped magnet coupled to the wheel facing the detector part.

9. The information input device of claim 8, wherein the detector part comprises a Hall sensor configured to detect changes in polarity of the magnet and generate a signal.
